(19) United States
(12) Patent Application Publication
(10) Pub. No.: US 2004/0134247 A1
(43) Pub. Date: Jul. 15, 2004

(54) Merchandise container

(76) Inventors: Peter Ernst, Mulheim/Ruhr (DE); Robert Ochsenschlager, Mulheim/Ruhr (DE)

Correspondence Address: WILLIAM COLLARD, COLLARD & ROE, P.C., 1077 NORTHERN BOULEVARD, ROSLYN, NY, 11576, US

(21) Appl. No.: 10/703,991

(22) Filed: Nov. 7, 2003

(30) Foreign Application Priority Data
Dec. 27, 2002 (DE) 202 20 141.4
Jun. 7, 2003 (EP) 03 012 985.2

(51) Int. Cl. E05B 47/00

(52) U.S. Cl. 70/257; 70/276; 70/269

(57) ABSTRACT

A merchandise container for receiving in particular highly valuable products, comprising a housing and at least one cover, whereby the cover and the housing have an electrically releasable locking system. This locking system can be released via an opening command. The locking system is continually activated and is only deactivated by an opening command during a delay time.

### CROSS REFERENCE TO RELATED APPLICATIONS

Applicant claims priority under 35 U.S.C. §119 of German Application No. 202 20 141.4 filed Dec. 27, 2002 and European Application No. 03 012 985.2 filed Jun. 7, 2003.

### BACKGROUND OF THE INVENTION

### 1. FIELD OF THE INVENTION

The invention relates to a merchandise container for receiving in particular, highly valuable products that have to be protected against theft. The container comprises a housing and at least one cover, whereby the cover and/or the housing have an electrically releasable locking system, and whereby the locking system can be released via a command issued for opening the container. The locking system ensures that the merchandise container can be opened only if it is released by the locking device as the result of a command for opening the container.

A merchandise container of the type specified above is described in U.S. Pat. No. 4,141,610 incorporated herein by reference, where the locking system is formed as an electromagnet with an armature that can be driven back and forth in the electromagnet and serves as the locking bolt. Consequently, the locking and opening of the known merchandise container necessarily requires that the locking bolt either penetrates the openings of the cover that align with each other, or completely vacates these openings. With this design, it is not possible to exclude malfunctioning.

Furthermore, a merchandise container of the type described above is described within the framework of DE 101 03 756 C1. This container is a device for receiving ordered merchandise and comprises a block-shaped container and a container door with a handle that is laterally mounted on the front side of the container. The door has a door lock so that the container can be locked.

The door lock can be actuated electrically for releasing the door. The door lock is electrically actuated by inputting a coded delivery/pick-up information, or via a type of general (or master) key of the user, with the help of an input device that is disposed next to the door. This design is unfortunately costly and is unsuitable for the presentation of merchandise in a sales room. To that extent, the aim of the present invention is to overcome the above problems.

The present invention is based on solving the problem of creating a merchandise container for receiving very valuable products, wherein these articles are offered and presented for sale in a highly-visible manner, but nonetheless protected against theft. In this case, the merchandise container can be operated in a simple and functionally flawless manner.

### SUMMARY OF THE INVENTION

The invention relates to a merchandise container containing a locking system that is continuously activated and deactivated only by an opening command during a preset delay time. An “activated locking system” is essentially a system that has a normal electromagnet that is continually supplied with current. The electromagnet is “dead” only during the adjustable delay time, so that the locking system will be deactivated having this dead time. The activated locking system locks the cover against the housing, whereas the cover is released when the locking system is deactivated.

As compared to the above, the locking system used in U.S. Pat. No. 4,141,610 is always deactivated after a defined period of time independent of any opening command and the position of the cover, for example, when it is no longer supplied with current. This is possible because the locking bolt is also retained in openings that cover each other when the current supply is shut off. However, the present invention permits the locking system to be operated both with and without the locking bolt, or for example, in a bolt-less manner. The last-mentioned variation is preferred, whereby the locking system primarily comprises an electromagnet and a counter element. When the locking system is in the activated state, electromagnetic attractive forces acting between the electromagnet and the counter element create the closure and locking of the cover. These forces of attraction are canceled only during the delay time.

After the opening command has been input, and following the preset delay time, the locking system, as a rule, is shifted into a position of “ready for locking”. Within the framework of the measures implemented according to the invention, the locking system is therefore continually activated in this position for “locking readiness”, whereby deactivation occurs only during the delay time, which, furthermore, can be adjusted.

This opening command can be transmitted to the locking system in a wire-bound manner or via a wireless manner wherein the locking system has a receiving device that is coordinated with an associated transmitter. The transmitter may be a hand-held transmitter that is operated by a cashier or some other authorized person, because the merchandise container described herein is set up in most cases within the immediate proximity of a cashier's station.

As stated above, a wire-bound operation is also possible. In this design, a switch, a scanner, or a comparable switching system is located in the area of a cash register or a cash collection system. This type of a switching system may have an optical display system that supplies information as to whether the cover is in the opened or closed state. The respective switching system is preferably supplied with current to assure that the merchandise container will open only once an authorized person has reported to a computer or to a comparable control unit of the cash collection system.

As a rule, the length of the delay time is selected so that a customer is able to remove the desired product from the merchandise container without any problem after the locking system has been released as a result of the transmitted opening command. Since the locking system is shifted again into the position of locking readiness after the preset delay time has elapsed, the cover is retained upon expiration of this delay time if and when it is moved near the locking position. This feature is ensured by the electromagnetic forces of attraction acting between the electromagnet and the counter element described above. These attractive forces start to act as soon as the locking system has been activated, and thus are acting also in the “readiness” position for locking. This position is substantially different from the locking position wherein the cover is not completely closed in the “ready-for-locking” position.

However, on the other hand, the “open” state of the cover can be maintained practically for any length of time. This means that in the “ready-for-locking” position, the locking system does not actively interfere with the movement of the cover. This is rather left up to the customer. However, if the cover is in the locking position or near the latter position, the “ready-for-locking” position ensures that the cover will be retained and the merchandise container will be locked.

One or more sliding elements are used as the cover, as a rule, which can be displaced lengthwise in the housing in guide elements. These guide elements are fixed on the longitudinal inside walls of the housing. The container uses two transparent, hood-like sliding elements, which serve as the cover so that the products contained in the merchandise container are visible. These sliding elements more or less overlap each other depending on the opening state of the merchandise container. When the cover is closed, the two sliding elements have the smallest amount of overlap, and when the cover is open, the two sliding elements have the maximum amount of overlap.

The guide elements are guide rails extending in the longitudinal direction of the housing so that these movements of the sliding elements can be executed smoothly. These guide rails are positioned on opposite sides of the container, and extend in parallel to each other with a first set or pair of guide rails extending along the length of the container for guiding a first cover and a second set of guide rails extending above the first set of guide rails along the length of the cover. This second set of guide rails are for allowing the second cover/sliding elements to slide along in a longitudinal axis along the container above the first cover. Running rollers that are mounted on the sliding elements are disposed in these guide rails. The guide rails may have a C-shaped cross section, with an opening in each rail that is directed at (or facing) the sliding element.

As described above, the locking system, in addition to a receiver, comprises an electromagnet, which can be a permanent magnet. This electromagnet or permanent magnet cooperates with the counter element, which is preferably a magnet control plate. The counter element or magnet control plate can be generally fixed on the end side of the respective sliding element. The electromagnet, on the other hand, is located in the interior of the housing, specifically on one or both transverse sides. Basically, any metal plate that is magnetically attracted with the help of the currents induced by the electromagnet can serve as the magnet control plate or counter element. In the simplest case, the magnetically controlled plate is a steel plate.

One or more contacts permit the scanning of the position of the cover or the sliding elements. These contacts may be locally associated with the respective electromagnet and form an assembly jointly with the electromagnet.

Now, to be able to realize in detail the delay time described above, the electromagnet is continually activated, and deactivated during the delay time only by the opening command. Thus, the cover can be opened only during the delay time. To indicate the position of the cover, it is possible to make an additional design for an indicator unit, which may be located externally on the merchandise container, or supplementally or alternatively mounted in the area of the cash collection system to inform the cashier about the actual condition of the merchandise container. The indicator unit indicates at least two conditions, namely, the status “ open” when the cover is open, or, when two sliding elements overlap one another, and the status “closed” when the contacts register that the cover or the sliding elements are in the closed condition.

In the end result, there is a merchandise container that is suited for selling and presenting articles of a high value that have to be protected against theft. At the same time, this container has an operation that is essentially free of problems and functionally safe. This is essentially accomplished in that the locking system is continually activated, and deactivated only by the opening command during the delay time.

Therefore, a customer can open one or more covers only during the delay or “open” time, which may amount to just a few seconds, for example only 5 seconds. The cover can remain in this opened state until the customer shifts the cover again into the locking position. If, at this point in time, the delay or opening or waiting time has elapsed, the locking system present in the “ready-for-locking” position ensures that the cover will be retained again.

This is accomplished in detail in that upon expiration of the delay time, the electromagnets of the locking system are again supplied with current and triggered. This triggering will consequently retain the associated magnet control plate or plates, respectively, as soon as this one plate or these plates, together with the cover or the two sliding elements, arrive within the proximity of one or more of the electromagnets. The contact reliably provides information about the given condition of the merchandise container at the same time.

After the opening command has been issued, the merchandise container or its locking system is again shifted into the “ready-for-locking” position after the preset delay time has elapsed. In this position, the locking system is active. Therefore, the cover can be opened only within the delay or opening or waiting time, which can be preset at a fixed value or in a variable manner. It is also conceivable to vary the delay time remotely by the hand-held transmitter or by the switching system on the cash collection system, such switching system being available in any case.

Therefore, the merchandise container described above can be actuated and monitored from a cash collection system that is located within the immediate proximity of the container. Thus, it is basically conceivable that the cash collection system, in addition to the merchandise container, controls and monitors other merchandise containers and the like, such as a cigarette dispenser. It is also possible to create a remote monitoring system if the indicator unit is installed in a remote monitoring station. Furthermore, the locking system can also include a transmitter, in addition to the receiving system. In such a case, such a transmitter transmits information about the condition of the cover to a hand-held transmitter, which includes a receiver.

Finally, the outside dimensions of the merchandise container are adapted on the whole to the specific purpose of application. For example, the merchandise container can be inserted in a cash register box, which is available in the area of the cash collection station in any case. In such a case, the merchandise container forms a block-shaped housing that is substantially open at the bottom. Another embodiment is a merchandise container that is closed on all sides.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of the merchandise container as defined by the invention;

FIG. 2 is a cross-sectional view of the device shown in FIG. 1 in the area of the guide rails for the sliding elements; and

FIG. 3 is a schematic block diagram of the electronic system for opening and closing the cover.

### DETAILED DESCRIPTION

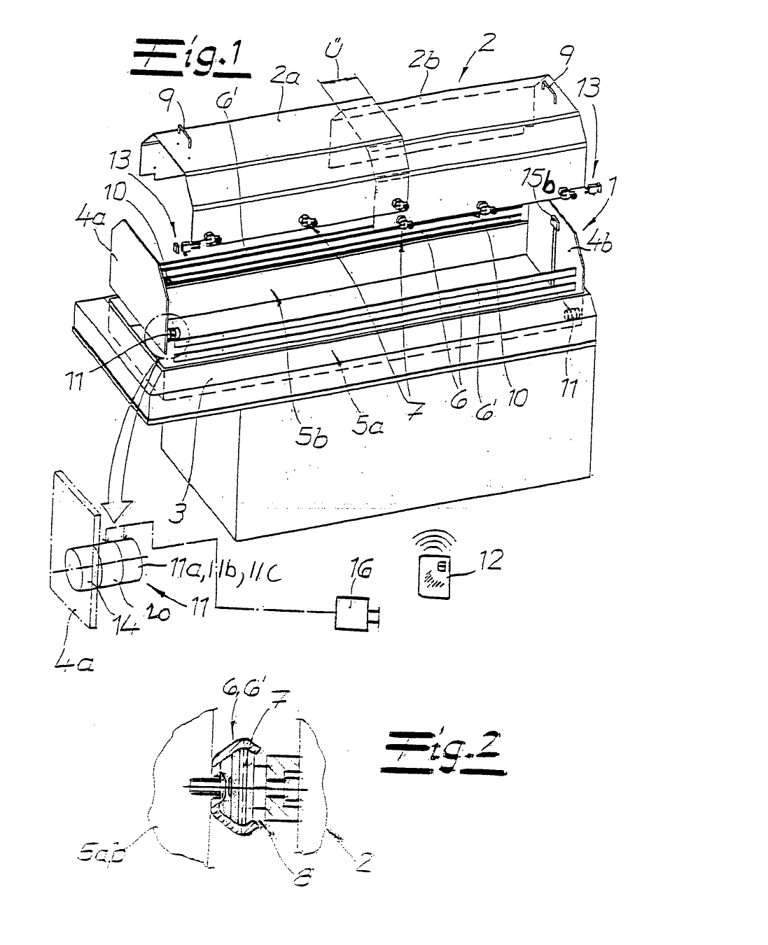

Turning now in detail to the drawings, FIGS. 1 and 2 show a merchandise container that is adapted to receive valuable articles, especially products of high quality, because the merchandise container can be opened by a customer only after an opening command has been issued. This opening command is issued in most cases by a cashier because the merchandise container is set up within the immediate proximity of a cashier's station (or cash collection system). Such a cash collection system is described, for example, in European patent EP 1 090 570 (application number 00 118 499.3) incorporated herein by reference. This, however, is not mandatory.

The valuable articles received in the merchandise container shown are, for example, electronic devices such as computers, watches, printers, television sets, digital cameras, devices for measuring blood pressure, radio transmission systems, etc. Other products, of course, can be placed in the container and also protected against theft. For these purposes, the basic structure of the merchandise container comprises a housing 1 and a transparent cover 2.

Housing 1 has a substantially block-shaped basic structure and, within the framework of this embodiment, is formed as an insert fitted into a tiered cash box drawer 3. Tiered cash register drawers normally receive one or more cash box inserts (not shown here in detail) with handle recesses, in which goods are received that are changed in most cases seasonally or at regular intervals. The drawer inserts can be removed to place the merchandise container in the cash box drawer 3. However, the cash box inserts may also be kept also in the interior of the merchandise container.

Housing 1 comprises a set of face parts 4a and 4b, as well as a set of side parts 5a and 5b, which together form an open, block-shaped insert. Bottom and side parts 5a and 5b for housing 1 are formed by cash box drawer 3. Housing 1, of course, may also comprise a separate bottom, and separate side parts 5a and 5b.

To make the articles disposed in the merchandise container visible, cover 2 is formed as transparent, and also face parts 4a and 4b are formed as transparent. These face parts, like cover 2, are produced from a transparent plastic, for example based on acrylic resin. Both face parts 4a and 4b and cover 2 are each beveled four times to obtain an external structure that is, as a whole, attractive and stable at the same time.

Cover 2 is composed of two transparent, hood-like sliding elements or separate covers 2a and 2b, which overlap each other in region “0”, depending on the opening condition of the merchandise container. So that two sliding elements 2a and 2b can be pushed one on top of the other, they are each guided in or on guide rails 6 and 6′ which serve as guide elements. Guide rails 6 extend in the longitudinal direction of housing 1, and are fixed on the inner side of housing 1 on associated side surfaces 5a and 5b. Guide rails 6 each receive running rollers 7 that are mounted on sliding elements 2a and 2b.

This representation shows that each sliding element 2a or 2b is equipped with four or six running rollers 7. Running rollers 7 are located on the lower edge at the end side of respective sliding element 2a, 2b. A set of guide rails 6, 6′ corresponds with each sliding element 2a, 2b. Since guide rails 6 and 6′ define different sliding planes, sliding elements 2a and 2b, which are identical, can be smoothly pushed one into another with the varying overlap “U”, and are guided in different planes. For example, guide rails 6′ are on a plane or level above guide rail 6 so that one part of the cover can slide over the other part.

Running rollers 7 have ball bearings (not shown here in any detail) and, as described above, are disposed in the guide rails 6 and 6′. FIG. 2 shows that the guide rails 6, 6′ have a C-shaped cross section and each have an opening 8 that is in each case directed at, (or facing) sliding elements 2a and 2b. Guide rails 6 and 6′ can have a U-shape, or even a V-shape cross section. To move sliding elements 2a and 2b back and forth, these sliding elements each have handle 9 on their surfaces. Handle 9, at the same time, limits the maximum achievable overlap “U”. Stops 10 also limit the maximum overlap “U”.

Guide rails 6 and 6′ and face parts 4a and 4b each can be jointly secured on cash box 3, so that the sliding elements 2a and 2b can be optionally inserted in or removed from housing 1 formed in such a manner. This depends on the articles presented in the given case.

To prevent theft, housing 1 comprises a locking system 11 that is triggered electrically and connected to each of the two face panels 4a and 4b. Cover 2 can have a corresponding locking system 11 as well.

Locking system 11 is actuated and unlocked (or released) via a wireless or wire-bound opening command. Sliding elements 2a and 2b, which were previously retained on the face panels 4a and 4b with the help of the respective locking system 11, are thus released, and can now be opened by a customer with the help of handles 9. After a preset delay time has elapsed, the locking system 11 is shifted into a “ready-for-locking” (or “locking readiness”) position. In this “ready-for-locking” position, the respective sliding element 2a, 2b is retained again as soon as the respective sliding element 2a or 2b is shifted into its locking (or closing) position.

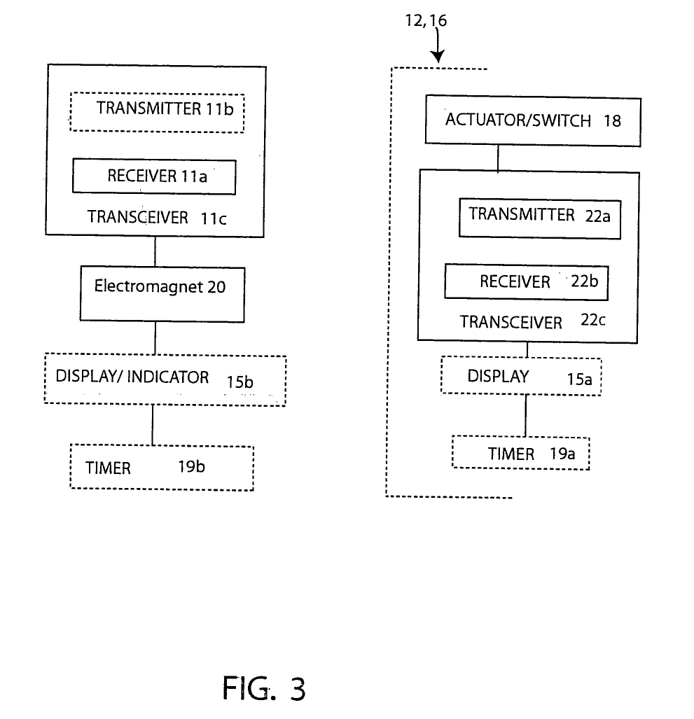

Within the framework of the present embodiment, locking system 11 comprises a receiver 11a, which can be seen in the enlarged cutout, as well as an electromagnet 20. Receiver 11a cooperates with a hand-held transmitter 12, (See FIG. 3) which is only indicated. This transmitter is operated, for example by a person in a warehouse manning a cashier's station.

It is also possible to supply electromagnet 20 with current with the help of a switching system 16 in a wire-bound manner. Both hand held transmitter 12 and switching system 16 are shown in greater detail in FIG. 3. For example, transmitter 12 or switching system 16 can have an actuator or switch 18 to activate the electromagnet and shut it off, or to consequently deactivate it. The respective switching system 16 can be installed in the area of the cashier's station. In that case, receiver 11a is formed as a relay or comparable converter to convert the signals coming from the switching system to perform the desired activation or shutdown of electromagnet 20.

As shown in FIG. 3, hand held transmitter 12 or switching system 16 can have a transmitter 22a, an optional receiver 22b or optionally have a combined transmitter/receiver in the form of a transceiver 22c. As soon as hand-held transmitter 12 or switching system 16 transmits an opening signal to receiver 11a of locking system 11, locking system 11 or its electromagnet 20 will release the respective sliding element 2a, 2b. Locking system 11 can also optionally include a transmitter 11b which can send signals back to indicate the position of the cover. Another optional form of this is to have both receiver 11a and transmitter 11b incorporated into one transceiver 11c.

Upon receiving the opening signal, in most cases, the two sliding elements 2a and 2b are simultaneously released on face panels 4a and 4b by the associated locking system 11. However, it is possible also to insure that either only sliding element 2a, or only sliding element 2b is opened. In detail, this is accomplished so that electromagnet 20 of locking system 11 is formed as a permanent magnet, which cooperates with a counter element 13 and, therefor, retains counter element 13 in the locked state. Counter element 13 is a magnet control plate that is fixed on the end side of the respective sliding element 2a, 2b. It is also possible to operate the other way round, thus, the respective sliding element 2a, 2b can have electromagnet 20 and receiver 11a, whereas the associated face plate 4a, 4b supports counter element 13.

Within the framework of the present embodiment, elements 11a and 20 are disposed on associated face plates 4a, 4b, so that the required current supply and, if need be, a control unit can be disposed in a covered manner in the cash drawer box 3 below the housing. Furthermore, a contact 14 is associated with both the electromagnet 20 and the locking system 11. Such a contact scans (or “queries”) the position of sliding element 2a, 2b. Electromagnet 20, receiver 11a and contact 14 jointly form a coherent, compact assembly unit 11a, 14, and 20.

Depending on the position or the opening or closing state of sliding elements 2a, 2b or cover 2, contacts 14 as a whole, control an indicator unit 15b. As shown in FIG. 1, this indicator unit is mounted on the one face panel 4b. Alternatively or additionally, however, this indicator unit can be placed within the area of the cashier's station as well in the form of indicator unit 15a. For example, it is possible that corresponding position signals that indicate the state or condition of cover 2, are transmitted to a remote indicator unit 15a in a wire-bound or wireless manner. In the case of wireless transmission, it is recommended to associate with receiver 11a of assembly 11a, 20, 14 a transmitter 11b that transmits corresponding signals of the contact 14 to indicator unit 15b (that contains the corresponding receiver).

The two locking systems 11 or their electromagnets 20 located on the face panels 4a, 4b are continually activated. This means that counter elements 13 located on the sliding elements 2a, 2b are retained by electromagnets 20, so that cover 2 cannot be opened. Only once locking system 11 has received an opening command from switching system 16 or the hand-held transmitter 12, will the electromagnets 20 release counter elements 13 for the duration of the adjusted delay or waiting or opening time. This delay time can be preset either at a fixed value, or it can be varied, for example with hand-held transmitter 12, or switching system 16 wherein there is a timer 19a incorporated therein or optionally by means of a timer 19b disposed adjacent to the receiver 11a for actuating the electromagnet.

The access to the goods contained in the merchandise container is released within the delay time of, for example 5 or 10 seconds. Sliding elements 2a, 2b can then be moved and cover 2 consequently can be opened. If cover 2 has not been opened within the delay or waiting time, it will be locked again after the delay time has elapsed. However, when sliding elments 2a, 2b have been opened, the “open” state is mantained until the sliding elements 2a, 2b move into their closing or locking position, so that the respective sliding element 2a, 2b can be retained (again) by the locking system 11 assuming the “ready-for-locking” position. The indicator unit 15 supplies the information about the actual state of the merchandise container. In the simplest case, this can be accomplished with the help of LED's.

Accordingly, while a few embodiments of the present invention have been shown and described, it is to be understood that many changes and modifications may be made thereunto without departing from the spirit and scope of the invention as defined in the appended claims.

What is claimed is:

1. A merchandise container for receiving highly valuable products, comprising:
a) a housing (1)
b) at least one cover (2) coupled to said housing (1),
c) an electrically releasable locking system (11), coupled to said housing and to said at least one cover (2) wherein said electrically releasable locking system (11) is continually activated and deactivated only by an opening command during a preset delay time to release said at least one cover, allowing said cover to move into an open position only during said delay time.

2. The merchandise container according to claim 1, wherein said electrically releasable locking system further comprises a plurality of wires for transmitting the opening command.

3. The merchandise container as in claim 1, wherein said electrically releasable locking system further comprises a wireless transceiver for transmitting and receiving an opening command.

4. The merchandise container according to claim 1, wherein said electrically releasable locking system (11) comprises:
a) at least one receiver (11a) which can be adapted to receive signals from a remote transmitter; and
b) at least one electromagnet (20) which is triggered by said at least one receiver (11a) for actuating said electromagnet (20).

5. The merchandise container as in claim 4, wherein said electrically releasable locking system further comprises a switching system (16) in communication with said at least one receiver and said electromagnet (20) for triggering said at least one electromagnet.

6. The merchandise container according claim 4, further comprising a counter element (13) wherein said at least one electromagnet (20) is a permanent magnet cooperating with said counter element (13) to retain said counter element (13) in a locked position.

7. The merchandise container according to claim 6, wherein said counter element (13) is a magnet control plate (13) fixed on an end side of said cover (2).

8. The merchandise container according to claim 1, further comprising at least one contact (14) coupled to a side of said cover, wherein a position of said cover (2) is located via said at least one contact (14).

9. The merchandise container according to claim 8, wherein said at least one contact (14) is disposed adjacent to said electromagnet (20) and forms a subassembly together with said at least one receiver (11a).

10. The merchandise container according to claim 4, wherein when said at least one receiver receives an opening command, and wherein the locking system (11) is shifted into a “ready-for-locking” position after the preset delay time has elapsed.

11. The merchandise container according to claim 1, further comprising an indicator unit (15a), (15b) for displaying a position of said cover (2).

12. The merchandise container according to claim 1, further comprising at least one guide element (6, 6′) wherein said cover (2) comprises at least one sliding element (2a, 2b) adapted to be longitudinally displaceable in said housing (1) in said at least one guide element (6, 6′).

13. The merchandise container according to claim 2, wherein said at least one sliding element comprises two sliding sections (2a, 2b), wherein said sliding sections are transparent and hood-shaped, and overlap one another in proportion to an open position of the merchandise container.

14. The merchandise container according to claim 12, further comprising at least one running roller (7) coupled to said cover, wherein said at least one guide element (6, 6′) is a guide rail (6, 6′) extending in a longitudinal direction of said housing (1), said guide rail receiving said running roller (7) mounted on said sliding elements (2a, 2b).

15. The merchandise container according to claim 4, wherein said at least one guide rail (6, 6′) has a C-shaped cross section and has an opening (8) facing said sliding sections (2a, 2b).
